(19) United States
(12) Patent Application Publication
(10) Pub. No.: US 2006/0054031 A1
(43) Pub. Date: Mar. 16, 2006

(54) Method and arrangement for monitoring the operating condition of presses, particularly packing presses

(76) Inventors: August Van Der Beek, City of Grevenbroich (DE); Gunter Bombosch, City of Datteln (DE); Thomas Kaprolat, City of Dortmund (DE); Bernhard Kock, City of Moers (DE)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/538,699

(22) PCT Filed: Dec. 12, 2003
(86) PCT No.: PCT/DE03/04112

§ 371 Date: Jun. 10, 2005

(30) Foreign Application Priority Data
Dec. 13, 2002 (DE) 10258660.8

(51) Int. Cl. B30B 13/00

(52) U.S. Cl. 100/35

(57) ABSTRACT

The aim of the invention is to monitor the operating condition of a press, especially a packing press (1) while preventing the machine parts that are involved in the relative movements from fretting. Said aim is achieved by a) detecting amplitudes of vibrations during the time and/or a distance of a relative movement occurring between at least one compressor (3.1, 3.2, 3.3) and/or a door (5.1) and the press case (2.2) within a cycle that lasts from the beginning to the end of the compression process and the ejection of the pressed article, and predefining an admissible oscillation amplitude of the entire press within the control mechanism (16.2) as a “normal condition” for increments of the duration and/or the distance of the relative movements; b) generating an “alert value” lying above the maximum value established for the normal condition and a shut-off value lying above the alert value; c) inputting both threshold values of the alert value and the shut-off value in the control mechanism (16.2) of the press (1) for each relevant relative movement or each increment of the duration and/or the distance of the relative movement; and d) controlling operation of the press during the cycle lasting from the beginning to the end of the compression process or during the relevant relative movement by means of the control mechanism (16.2), a signal being displayed when the alert value and/or the shut-off value has/have been reached.

### TECHNICAL FIELD

The invention relates to a method and an arrangement for monitoring the operating condition of presses, particularly packing presses for the production of pressed objects, such as from scrap and sheet metal wastes.

### PRIOR ART

For example, shear packing presses according to DE 198 04 789 are known, which substantially comprise a hopper with cutting edge, compactor with shearing knives guided horizontally therein, a press case arranged at right angles thereto with compactor guided therein and a pack chamber, arranged horizontally and transversely with respect to the hopper and with a compactor guided horizontally.

In practical embodiments, hopper and press case open into a common chamber accommodating the pack-like pressed object, the aforementioned pack chamber. The walls of the hopper, press case and pack chamber form the housing of the shear packing press. The pack chamber has an opening for the door to be displaced horizontally, through which the ejected pressed object passes. The compactor and the door are moved by hydraulic pistons/cylinders, which are connected to a hydraulic drive system.

To produce pressed objects, preferably packs, from waste material, in particular from scrap and sheet metal wastes, by means of such known shear packing presses
a first compaction step for the pre-compaction of the material put in to the width of the pack is carried out by means of a compactor guided horizontally in the hopper, material possibly projecting beyond the compactor being cut off at the cutting edge by means of the shearing knife arranged on the compactor,
after that, a second compaction step for the intermediate compaction of the material pre-compacted to the pack width to the height of the pack is carried out by means of the compactor guided in the press case at right angles to the hopper,
then, a third compaction step for the final compaction of the material to the final density and length of the pack is carried out by means of the compactor guided horizontally in the pack chamber, horizontally and transversely with respect to the hopper, the finished pack, after reaching the final density and length, being ejected from the pack chamber through the door, and
finally, the control of these compaction steps is carried out by means of a drive system producing a hydraulic pressure.

This basic principle has proven worthwhile in practice but there is a requirement for functional improvements with regard to monitoring the operating condition of presses.

In this case, presses are not just understood to mean the type mentioned at the beginning. In the sense of the invention, the requirement for an improvement in the monitoring of the operating condition extends only as far as presses, i.e. machines, in which, because of the relative movement between a driven compactor and a press case or table absorbing the compaction pressure for the pressed object, what is known as a stick-slip effect occurs. This applies to presses that act one-dimensionally, two-dimensionally and also three-dimensionally (specifically of the type mentioned at the beginning).

In presses, this stick-slip effect because of the friction between the surfaces of the machine parts involved sliding on one another is expressed by chattering and/or creaking noises. The cause of this is that, during the aforementioned relative movement, under the action of the relatively high pressures and components turning away from the actual pressing direction, the movement changes from adhesive friction to moving friction and vice versa. The acoustically perceivable oscillations which are therefore produced are in turn produced by the fact that the entire machine, in particular the machine part respectively involved, is set oscillating.

In the extreme case, as a result of a high-frequency frictional movement, the frictional surface respectively involved can weld locally, which is generally designated “fretting”. For the machine, this means considerable damage, which can be rectified only with considerable effort. Furthermore, a loss of production arises for the operator, which leads to consequential damages.

### SUMMARY OF THE INVENTION

The invention has the object of developing a method and an arrangement for monitoring the operating condition of presses, in particular packing presses, damaging oscillation stresses being detected in good time and “fretting” of the machine parts involved in the relative movements being avoided.

According to the invention, this object is achieved by the features of claims 1 to 12.

### BRIEF DESCRIPTION OF THE DRAWINGS

In the drawings:

FIG. 1 shows the schematically illustrated arrangement according to the invention using the example of a packing press, in a perspective illustration,

FIG. 2 shows a plan view with a schematically illustrated arrangement according to the invention.

### BEST WAY OF IMPLEMENTING THE INVENTION

The invention will be explained in terms of its basic arrangement and the active principle on a packing press operating three-dimensionally, in accordance with the following exemplary embodiment.

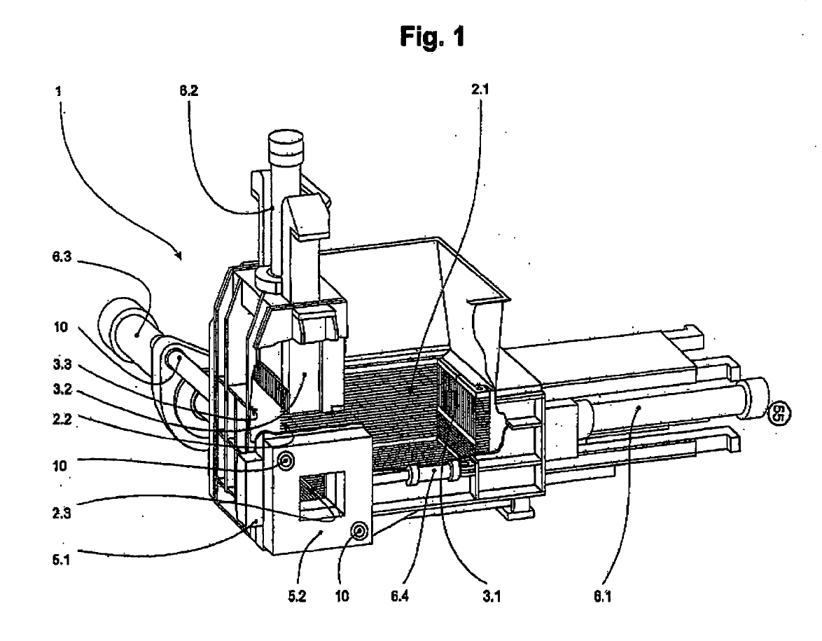

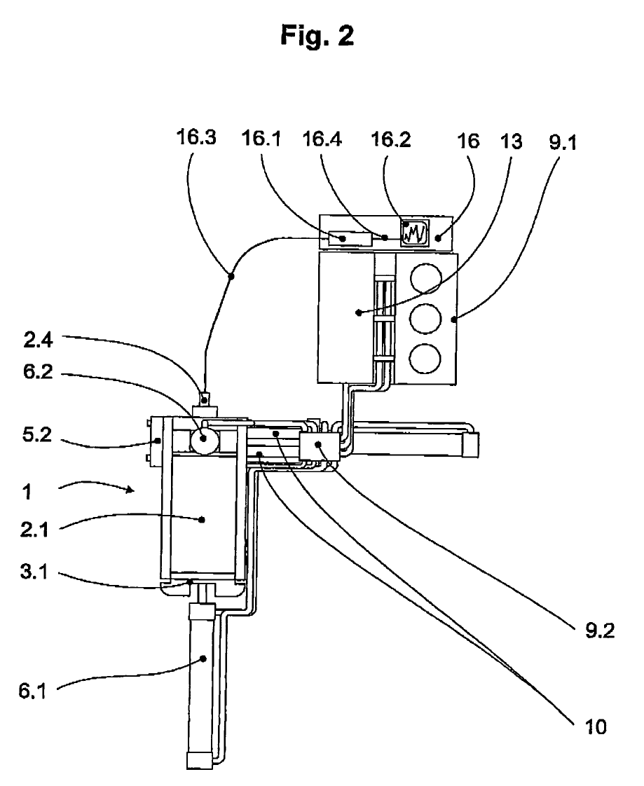

According to FIG. 1, the packing press 1 substantially comprises a press case 2.2 and a pack chamber 2.3, and a first compactor 3.1 driven by a first piston/cylinder unit 6.1, and a second compactor 3.2 driven by a second piston/cylinder unit 6.2 and a third compactor 3.3 driven by a third piston/cylinder unit 6.3 (FIG. 2a). A door 5.1 connected to a fourth piston/cylinder unit 6.4 is guided in a door case 5.2 such that it can be moved horizontally. The door case 5.2 is fixed to the housing part of the pack chamber 2.3 by means of a tie rod 10, the tie rod 10 at the same time absorbing the pressure against the door 5.1 exerted on a pressed object, not illustrated, by the third piston/cylinder unit 6.3 by means of the third compactor 3.3.

In accordance with the erection possibility illustrated in FIG. 2 for a hydraulic drive system 9.1 of the packing press 1, said system substantially comprises a control block 9.2, a hydraulic tank 13 and a switch cabinet 16, which form a compact structural unit which can be preassembled on its own. With the switch cabinet 16 is a controller 16.2, which is connected via a connecting cable 16.4, a charge amplifier (coupler) 16.1 and a dimension line 16.3 to a sensor 2.4 on an end wall of the press case 2.2 of the packing press 1.

The following basic series of steps or sequences and combinations are typical of the operation of the packing press 1:
the pre-compaction of the material by means of the first compactor 3.1 in the first compaction step,
the following second compaction step by means of the second compactor 3.2,
the third compaction step, carried out by means of the third compactor 3.3, in which the first compactor 3.1 is already in a position exposing the opening of the pack chamber 2.3.

In this case, the return strokes of the compactors 3.1, 3.3 can be coupled, the compactor 3.3 then initially covering part of the distance on its own and the remainder of the distance together with the compactor 3.1.

The door 5.1 is closed at the same time as the return stroke of the third compactor 3.3 by means of hydraulic isolation, or opened at the same time as the return stroke of the compactor 3.2 by means of hydraulic isolation.

For all these sequences, use is made of a controller 16.2, which monitors the movement sequences of the compactors 3.1, 3.2, 3.3 and the door 5.1 during the cycles for the production of the pressed object, not illustrated.

These movements sequences of the compactors 3.1, 3.2, 3.3 and of the door 5.1, specifically with the involvement of relatively high forces, in critical positions produce the undesired stick-slip effect already described in more detail at the beginning which, according to the object, is to be detected in good time in order to avoid “fretting” of the machine parts involved in the movement sequences.

By means of the arrangement of the controller 16.2, which is constructionally relatively simple but surprising in its effect, with the sensor 2.4 fitted to the end wall of the press case 2.2 for measuring oscillation amplitudes, the measuring line 16.3 for passing on the measured values with a coupler as charge amplifier 16.1 and a connecting cable 16.4, the method according to the invention is carried out as follows.

Relative movements taking place during the time and/or distance between each compactor 3.1, 3.2, 3.3 and the press case 2.2 and also the door 5.1 in the cycle from the start until the end of the pressing operation and the ejection of the pressed object, not illustrated, the oscillation amplitudes are registered continuously via the sensor 2.4. After that, a permissible oscillation amplitude for the packing press 1 is registered within the controller 16.2 as a “normal condition” for the time and/or distance increments of the relative movements.

Then, an “alarm value” with a magnitude 20% higher than the maximum measured value of the oscillations in the normal condition is generated, and a “shut-off value” having a magnitude 40% higher than the previous maximum measured value is generated and the two limiting values are entered into the controller 16.2 of the press 1 for each time and/or distance increment, with the effect of an incremental memory.

The operation of the press is ultimately managed, completing the series of steps according to the invention, by the use of a program integrated into the controller 16.2, in such a way that
a) in a learning phrase, the maximum oscillation amplitudes during the various relative movements belonging to the pressing cycle or the movement increments are recorded,
b) automatic generation of the “alarm” and “shut-off values” is carried out,
c) in the actual active phase, the measured values of the oscillation amplitudes during the pressing operation are registered and compared continuously with the respective associated “alarm and shut-off values” belonging to the distance and/or time increment,
d) appropriate actions are triggered automatically if the values are exceeded.

The idea of an incremental memory is used completely in the system for monitoring the operating condition of the packing press in order to achieve the object, namely the prevention of “fretting” of relevant machine parts, in that “alarm” or “stop” are triggered automatically when a current measured value goes beyond a tolerance value.

It is expedient to indicate the values “normal condition”, “alarm value” and “shut-off value” on a monitor, not designated, of an operator guidance system in the controller 16.2 of the packing press 1.

### COMMERCIAL APPLICABILITY

Although its effect is associated with substantially increased serviceability for the operator of machines of the generic type, the invention may be implemented with relatively simple means, even retrofitting according to the invention of presses already in operation being unproblematic.

### LIST OF DESIGNATIONS

1=Shear packing press
2.1=Hopper
2.2=Press case
2.3=Pack chamber
2.4=Sensor
3.1=First compactor
3.2=Second compactor
3.3=Third compactor
5.1=Door
5.2=Door case
6.1=First piston/cylinder unit
6.2=Second piston/cylinder unit
6.3=Third piston/cylinder unit
6.4=Fourth piston/cylinder unit
9.1=Hydraulic drive system
9.2=Control block
10=Tie rod
13=Hydraulic tank
16=Switch cabinet
16.1=Coupler/charge amplifier
16.2=Controller
16.3=Measuring line
16.4=Connecting cable

1. A method for monitoring the operating condition of a press, particularly a packing press (1), for the production of pressed objects, preferably packs made from waste material, in particular from scrap and sheet metal wastes, comprising
at least one step which can be registered by measurement in terms of time and/or distance for compacting the material put in in a press case (2.2)
a step which can be registered by measurement in terms of time and/or distance for ejecting the finished pack or pressed object,
and a controller (16.2) for carrying out these steps by means of a drive system (9.1) producing a hydraulic pressure, and
registration of amplitudes of the oscillation condition of the press and predefinition of at least one permissible oscillation amplitude as a reference value for the controller (16.2) of the press (1), characterized by
a) registration of the amplitudes of oscillations during the time or a distance of a relative movement taking place between at least one compactor (3.1, 3.2, 3.3) and/or machine element such as a door (5.1) and the press case (2.2) in the cycle from the start until the end of the pressing operation, and also ejection of the pressed object and predefinition of a permissible oscillation amplitude of the entire press within the controller as a “normal condition” for time or distance increments of the relative movements,
b) generation of an “alarm value” with a magnitude which is above the maximum value in the “normal condition”, and generation of a “shut-off value” with a magnitude which is above the “alarm value”,
c) entry of both limiting values from “alarm value” and “shut-off value” for each relevant relative movement or for each time or distance increment of the relative movement into the controller of the press (1) and
d) operation of the press by means of the controller (16.2) with indication of a signal when the “alarm value” is reached and/or the “shut-off value” is reached during the cycle from the start until the end of the pressing operation or the relevant relative movement.

2. The method as claimed in claim 1, characterized in that the “alarm value” to be generated lies below the value of the amplitude which causes the stick-slip effect triggering fretting of the machine parts involved in the relative movement, so that no alarm is reported during fault-free operation.

3. The method as claimed in claim 1, characterized in that the “shut-off value” to be generated lies below the value of the amplitude which causes the stick-slip effect triggering fretting of the machine parts involved in the relative movement.

4. The method as claimed in claim 1, characterized in that the amplitudes of the oscillations within the cycle of a relative movement of the machine parts involved in the pressing and ejection operation are registered while excluding non-critical oscillation amplitudes of other machine parts, and after that the values “normal condition”, “alarm value” and “shut-off value” are stored in the controller (16.2).

5. The method as claimed in one of claims 1 to 4, characterized in that the oscillation amplitudes are measured only during the movement of at least one of the piston/cylinder unit (6.1, 6.2, 6.3) acted on by a hydraulic drive system (9.1).

6. The method as claimed in one of claims 1 to 4, characterized in that when the “alarm value” and/or the “shut-off value” is reached, the operation of the press can be switched off automatically.

7. The method as claimed in one of claims 1 to 6, characterized in that the oscillation amplitudes are measured by means of a sensor (2.4) fixed to an exposed point of the press case (2.2).

8. The method as claimed in one of claims 1 to 7, characterized by the use of an integrated program for the controller (16.2) of the press, the program comprising the steps of
a) a learning phase with recording of the maximum oscillation amplitude during the various relative movements belonging to the pressing cycle or the relative movement increments,
b) automatic generation of alarm and shut-off values,
c) an active phase with registration of the measured values of the oscillation amplitudes during the pressing operation and continuous comparison with the respective alarm and shut-off values belonging to the distance or time increment and
automatic triggering of appropriate actions if alarm and shut-off values are exceeded.

9. The method as claimed in one of claims 1 to 8, characterized in that the “alarm value” is set to be an order of magnitude around 20% higher than the maximum measured value of the oscillations in the “normal condition”, and the “shut-off value” is set to be an order of magnitude around 40% higher than the measured value of the oscillations in the “normal condition”, and are entered into the program for the control of the press (16.2).

10. An arrangement for monitoring the operating condition of presses in order to carry out the method as claimed in claim 1 to 9, comprising
the controller (16.2),
at least one sensor (2.4) fitted to an exposed point of the press case (2.2) for measuring the oscillation amplitudes,
a measuring line (16.3) for passing on the measured values with a coupler as charge amplifier (16.1), and
a connecting cable.

11. The arrangement as claimed in claim 10, characterized in that the sensor (2.4) is fitted to an end of the press case (2.2).

12. The arrangement as claimed in claim 10, characterized in that the values “normal condition”, “alarm value” and “shut-off value” can be indicated on a monitor of an operator guidance system in the controller (16.2) of the packing press.
